(19) United States
(12) Patent Application Publication
(10) Pub. No.: US 2025/0293297 A1
(43) Pub. Date: Sep. 18, 2025

(54) METAL-CONTAINING ELECTROLYTE AND MANUFACTURE METHOD THEREOF

(71) Applicant: National Taiwan University of Science and Technology, Taipei City (TW)

(72) Inventor: Fu-Ming WANG, New Taipei City (TW)

(21) Appl. No.: 18/981,688

(22) Filed: Dec. 16, 2024

(30) Foreign Application Priority Data
Mar. 18, 2024 (TW) 113110019

(51) Int. Cl. H01M 10/0565; H01M 10/0525

(52) U.S. Cl. CPC H01M 10/0565; H01M 10/0525; H01M 2300/0082

(57) ABSTRACT

A metal-containing electrolyte is provided in some embodiments of the present disclosure, including a structure of formula 1 as follows, in which “R” is hydrogen or an alkyl group including 1 to 20 carbon atoms; “M” is a metal element; “a” is an integer from 5 to 50; “b” is an integer from 2 to 100; and “z” is an integer from 0 to 10;

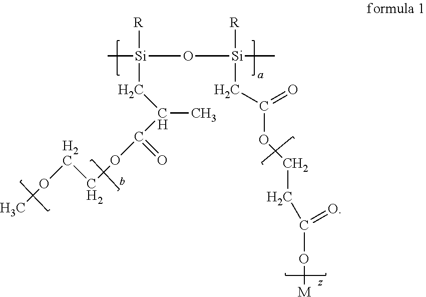

### CROSS-REFERENCE TO RELATED APPLICATION

This application claims priority to Taiwan Application Serial Number 113110019, filed Mar. 18, 2024, which is herein incorporated by reference.

### BACKGROUND

### Field of Invention

A metal-containing electrolyte and a manufacture method thereof are provided in some embodiments of the present disclosure.

### Description of Related Art

Lithium-Ion Battery (LIB) is widely used due to its advantages such as high energy density, high output voltage, and low self-discharge rate. The solid electrolyte in LIB used to known is generally high molecular polymer. At the same time, in order to improve the ionic conductivity, it is often necessary to add additional conductive agents such as lithium salts and graphene oxides to improve conductivity. However, the addition of the conductive agents is not only expensive, but may also cause variations in the mechanical properties of the polymer.

Therefore, how to provide an electrolyte with good conductivity without the need for additional conductive agents is a problem to be solved.

### SUMMARY

A metal-containing electrolyte is provided in some embodiments of the present disclosure, including a structure of formula 1 as follows:

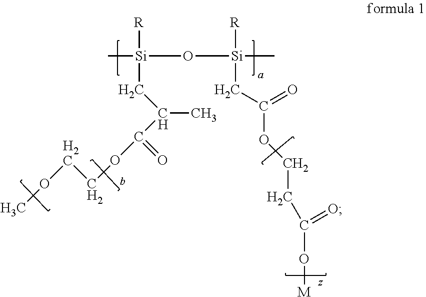

in which “R” is hydrogen or an alkyl group including 1 to 20 carbon atoms;
“M” is a metal element;
“a” is an integer from 5 to 50;
“b” is an integer from 2 to 100;
“z” is an integer from 0 to 10.

In some embodiments, M is an element of Group 1 of Periodic Table of Elements.

In some embodiments, the metal-containing electrolyte has a structure of formula 2 or formula 3 as follows:

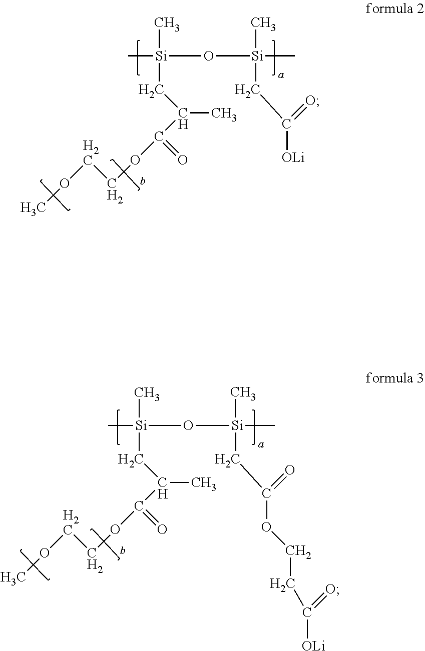

in which “a” is an integer from 5 to 50; “b” is an integer from 2 to 100.

In some embodiments, the metal-containing electrolyte further includes an alkali metal salt.

In some embodiments, the alkali metal salt includes lithium bis(fluorosulfonyl)imide, potassium bis(fluorosulfonyl)imide, sodium bis(fluorosulfonyl)imide, lithium bis(trifluoromethanesulfonyl)imide, potassium bis(trifluoromethanesulfonyl)imide, sodium bis(trifluoromethanesulfonyl)imide, or a combination thereof.

In some embodiments, a weight ratio of the metal-containing electrolyte and the alkali metal salt is from 5:95 to 95:5.

A method of manufacturing a metal-containing electrolyte is provided in some embodiments of the present disclosure, including: providing a siloxane polymer, poly(ethylene glycol) methyl ether methacrylate and an alkenoic acid compound; mixing the siloxane polymer, the poly(ethylene glycol) methyl ether methacrylate and the alkenoic acid compound in an organic solvent, and obtaining a first mixture solution; heating the first mixture solution to allow an alkenyl group of the poly(ethylene glycol) methyl ether methacrylate and an alkenyl group of the alkenoic acid compound to separately perform a hydrosilylation reaction with a silicon-hydrogen bond of the siloxane polymer to form an initial electrolyte, thereby obtaining a first reaction solution including the initial electrolyte; providing a metal compound; mixing the metal compound and the first reaction solution to obtain a second mixture solution; and heating the second mixture solution to allow a metal ion of the metal compound to form an ionic bond with oxygen of a hydroxyl group of the initial electrolyte, and obtaining a metal-containing electrolyte.

In some embodiments, the siloxane polymer includes polymethylhydrosiloxane.

In some embodiments, the alkenoic acid compound includes acrylic acid, carboxyethyl acrylate, or a combination thereof.

In some embodiments, at the step of mixing the siloxane polymer, the poly(ethylene glycol) methyl ether methacrylate and the alkenoic acid compound in the organic solvent, a molar ratio of the siloxane polymer and the poly(ethylene glycol) methyl ether methacrylate is from 1:5 to 5:1.

In some embodiments, at the step of mixing the siloxane polymer, the poly(ethylene glycol) methyl ether methacrylate and the alkenoic acid compound in the organic solvent, a molar ratio of the poly(ethylene glycol) methyl ether methacrylate and the alkenoic acid compound is from 1:5 to 5:1.

In some embodiments, the organic solvent includes tetrahydrofuran, n-hexane, or a combination thereof.

In some embodiments, the step of mixing the siloxane polymer, the poly(ethylene glycol) methyl ether methacrylate and the alkenoic acid compound in the organic solvent includes adding platinum.

In some embodiments, the step of heating the first mixture solution includes heating the first mixture solution in an inert gas atmosphere at from 70° C. to 90° C.

In some embodiments, the metal compound includes a metal ion of Group 1, Group 2, or a combination thereof of Periodic Table of Elements.

In some embodiments, at the step of mixing the metal compound and the first reaction solution, a molar ratio of the alkenoic acid compound and the metal compound is from 1:20 to 20:1.

In some embodiments, the step of heating the first mixture solution includes heating the second mixture solution in an inert gas atmosphere at from 70° C. to 90° C.

In some embodiments, after the step of heating the second mixture solution, the method includes mixing the metal-containing electrolyte and an alkali metal salt.

In some embodiments, a weight ratio of the metal-containing electrolyte and the alkali metal salt is from 5:95 to 95:5.

In some embodiments, the alkali metal salt includes lithium bis(fluorosulfonyl)imide, potassium bis(fluorosulfonyl)imide, sodium bis(fluorosulfonyl)imide, lithium bis(trifluoromethanesulfonyl)imide, potassium bis(trifluoromethanesulfonyl)imide, sodium bis(trifluoromethanesulfonyl)imide, or a combination thereof.

It is to be understood that both the foregoing general description and the following detailed description are examples and are intended to provide further explanation of the present disclosure as claimed.

### BRIEF DESCRIPTION OF THE DRAWINGS

In order to allow the above-mentioned and other purposes, features, advantages and embodiments of the present disclosure to be more clearly understood, accompanying drawing is described as follows:

FIG. 1 is a flow chart of a method of manufacturing a metal-containing electrolyte in some embodiments of the present disclosure.

FIG. 2 illustrates a relationship figure between specific capacity, coulombic efficiency and cycle number of each group of half-cell systems during multiple charge and discharge cycles after performing a charge and discharge cycle test for comparing the half-cell systems of the solid electrolytes separately including Group AAM950 and Group CEAM950 in the examples of the present disclosure.

FIG. 3 illustrates a relationship figure between potential and specific capacity of each group of half-cell systems during multiple charge and discharge cycles after performing a charge and discharge cycle test for comparing the half-cell systems of the solid electrolytes separately including Group AAM950, Group CEAM950 and liquid electrolyte (Group EC:PC:DEC) in the examples of the present disclosure.

FIG. 4A and FIG. 4B illustrate a relationship figure between potential and specific capacity of each group of half-cell systems during multiple charge and discharge cycles after performing a charge and discharge cycle test for comparing the half-cell systems of the solid electrolytes including Group potassium salts (FIG. 4A) or Group lithium salts (FIG. 4B) in the examples of the present disclosure, respectively.

FIG. 5A illustrates a relationship figure between specific capacity, coulombic efficiency and cycle of each group of half-cell systems during multiple charge and discharge cycles after performing a charge and discharge cycle test for comparing the half-cell systems of the solid electrolytes including different types and contents of lithium salts in the examples of the present disclosure.

FIG. 5B illustrates a relationship figure between specific capacity, coulombic efficiency and cycle of each group of half-cell systems during multiple charge and discharge cycles after performing a charge and discharge cycle test for comparing the half-cell systems of the solid electrolytes including different weight ratios of CEAM950 and lithium salts (LiTFSI) in the examples of the present disclosure.

FIG. 6 illustrates a relationship figure between specific capacity and cycle of each group of half-cell systems during multiple charge and discharge cycles after performing a charge and discharge cycle test for comparing Group sodium half-cell and the half-cell system including liquid electrolyte (Group EC:PC:DEC) in the examples of the present disclosure.

### DETAILED DESCRIPTION

It is to be understood that different implementations or embodiments provided in the following may implement different features of the subject matter of the present disclosure. The embodiments of specific components and arrangements are used to simplify the disclosure and not to limit the disclosure. Of course, these are only examples and are not intended to be limiting. For example, the description below that the first feature is formed on the second feature includes the two being in direct contact, or there are other additional features between the two that are not in direct contact. Furthermore, the present disclosure may repeat reference numerals and/or symbols in the various embodiments. Such repetition is for simplicity and clarity and does not represent a relationship between the various embodiments and/or configurations discussed.

Terms used in this specification generally have their ordinary meanings in the art and in the context in which they are used. The embodiments used in this specification, including examples of any terms discussed herein, are illustrative only and do not limit the scope and meaning of the disclosure or any exemplified terms. Likewise, the present disclosure is not limited to some of the implementations provided in this specification.

It will be understood that, although the terms “first,” “second,” etc., may be used herein to describe various elements, these elements should not be limited by these terms. These terms are used to distinguish one element from another. For example, a first element could be termed a second element, and similarly, a second element could be termed a first element, without departing from the scope of the embodiments.

As used herein, the phrase “and/or” includes any and all combinations of one or more of the associated listed items.

As used herein, the terms “comprise,” “include,” “has,” etc. are to be understood as open-ended, that is, to mean including but not limited to.

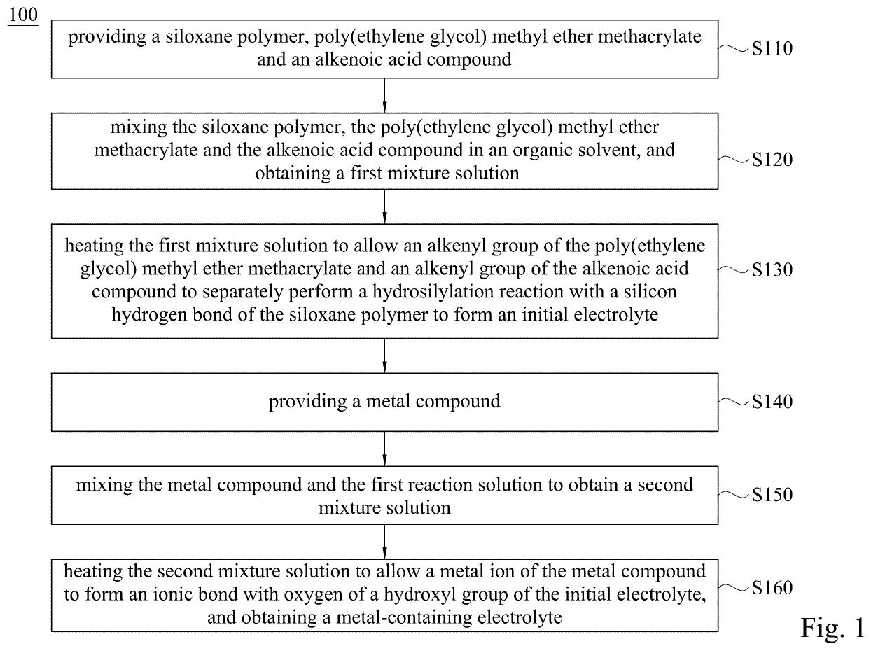

Please refer to FIG. 1, a method 100 of manufacturing a metal-containing electrolyte is provided in some embodiments of the present disclosure, including step S110 to step S160.

The method 100 forms an ionic bond (such as the prelithiation treatment) between a metal ion of a metal compound and oxygen of a hydroxyl group in an initial electrolyte, thereby obtaining a metal-containing electrolyte that can carry metal ions.

Compared with conventional polymer electrolytes, the metal-containing electrolyte carrying the metal ion has better electrical conductivity. In addition, since there is no need to add additional metal salts, the metal-containing electrolyte can have good electrical conductivity, and the problem of changes of mechanical property (such as being too hard or too soft) that may occur due to the addition of excessive metal salts to conventional solid electrolyte can be avoided.

First, please refer to step S110, a siloxane polymer, poly(ethylene glycol) methyl ether methacrylate and an alkenoic acid compound is provided.

In some embodiments, the siloxane polymer includes polymethylhydrosiloxane (PMHS). In some embodiments, 1 PEGMEMA includes 2 to 100 repeating —CH₂—CH₂—O-segment. In some embodiments, the alkenoic acid compound includes an organic acid having an alkenyl group and a carboxyl group, such as acrylic acid (AA), carboxyethyl acrylate (CEA), or a combination thereof.

Please refer to step S120, the siloxane polymer, the poly(ethylene glycol) methyl ether methacrylate (PEGMEMA) and the alkenoic acid compound are mixed in an organic solvent, and a first mixture solution is obtained.

In some embodiments, the organic solvent includes tetrahydrofuran(tetrahydrofuran, THF), n-hexane, or a combination thereof. Compared with other organic solvents, siloxane polymer, PEGMEMA and alkenoic acid compound have better solubility in THF.

In some embodiments, at the step of mixing the siloxane polymer, PEGMEMA and the alkenoic acid compound in the organic solvent, a molar ratio of the siloxane polymer and PEGMEMA is from 1:5 to 5:1, such as 1:5, 2:5, 3:5, 4:5, 1:1, 2:1, 3:1, 4:1, 5:1, or a value between the aforementioned intervals. If the molar ratio is too high or too low, the efficiency of the following bonding reaction is limited.

In some embodiments, at the step of mixing the siloxane polymer, PEGMEMA and the alkenoic acid compound in the organic solvent, a molar ratio of PEGMEMA and the alkenoic acid compound is from 1:5 to 5:1, such as 1:5, 2:5, 3:5, 4:5, 1:1, 2:1, 3:1, 4:1, 5:1, or a value between the aforementioned intervals. If the molar ratio is too high or too low, the efficiency of the following bonding reaction is limited.

In some embodiments, the step of mixing the siloxane polymer, PEGMEMA and the alkenoic acid compound in the organic solvent includes adding platinum. It can be understood that platinum can serve as a catalyst to improve the efficiency of subsequent bonding.

Please refer to step S130, the first mixture solution is heated to allow an alkenyl group of PEGMEMA and an alkenyl group of the alkenoic acid compound to separately perform a hydrosilylation reaction with a silicon-hydrogen bond of the siloxane polymer to form an initial electrolyte, thereby obtaining a first reaction solution including the initial electrolyte.

Specifically, PEGMEMA performs a hydrosilylation reaction with the silicon-hydrogen bond of the siloxane polymer through the alkenyl group, and then replaces hydrogen of the silicon-hydrogen bond and bonds to the siloxane polymer. The alkenoic acid compound undergoes a hydrosilylation reaction with another silicon-hydrogen bond in the siloxane polymer through the alkenyl group, thereby replacing hydrogen of the silicon-hydrogen bond and bonding to the siloxane polymer. It is worth emphasizing that by selecting PEGMEMA and the alkenoic acid compound with carbonyl groups (C═O), and allowing them to bond with the siloxane polymer, respectively, it can ensure that the subsequent metal-containing electrolyte has the carbonyl group (C═O), thereby giving the metal-containing electrolyte the property of attracting a metal ion to improve electrical conductivity. In some embodiments, the alkenoic acid compounds with different numbers of carbonyl groups can also be used according to demands to adjust the conductivity of the metal-containing electrolyte.

In some embodiments, step S130 includes heating the first mixture solution in an inert gas atmosphere at from 70° C. to 90° C., such as 70° C., 75° C., 80° C., 85° C., 90° C. or a value between the aforementioned intervals. If the temperature is too high, the alkenyl group of PEGMEMA and the alkenyl group of the alkenoic acid compound may polymerize first, causing the reactivity with the siloxane polymer to decrease and the product structure to be different from expected. If the temperature is too low, the reaction efficiency will be limited. In addition, by using the inert gas, air can be isolated to avoid the generation of other impurities and ensure the reaction proceeds smoothly. In some embodiments, the inert gas includes nitrogen gas, argon gas, helium gas, or a combination thereof.

Please refer to step S140, the metal compound is provided.

In some embodiments, the metal compound includes a metal ion of Group 1, Group 2, or a combination thereof of Periodic Table of Elements. In some embodiments, the metal compound is the metal salt with a dissociation degree higher than 50% in the organic solvent, in which the metal is Group 1, Group 2, or a combination thereof of Periodic Table of Elements. In some embodiments, the metal compound includes lithium hydroxide, potassium hydroxide, lithium carbonate, potassium carbonate, lithium phosphate, lithium sulfate, lithium nitrate, or a combination thereof. Depending on demands of the battery performance, the metal compound with the suitable metal ions can be selected for subsequent ionic bonding reactions (such as prelithiation treatment).

Please refer to step S150, the metal compound and the first reaction solution are mixed to obtain a second mixture solution.

In some embodiments, at step S150, a molar ratio of the alkenoic acid compound and the metal compound is from 1:20 to 20:1, such as 1:20, 1:15, 1:10, 1:5, 1:1, 5:1, 10:1, 15:1, 20:1, or a value between the aforementioned intervals. molar ratio. If the molar ratio is too high, the viscosity of the polymer will increase. If the molar ratio is too low, the reaction efficiency between the metal ion and the alkenoic acid compound will be limited.

Please refer to step S160, the second mixture solution is heated to allow a metal ion of the metal compound to form an ionic bond with oxygen of a hydroxyl group of the initial electrolyte, and a metal-containing electrolyte is obtained.

In some embodiments, step S160 includes heating the second mixture solution in an inert gas atmosphere at from 70° C. to 90° C., such as 70° C., 75° C., 80° C., 85° C., 90° C. or a value between the aforementioned intervals. Since the technical features here are similar to the aforementioned step S130, they will not be described again here.

In some embodiments, the metal-containing electrolyte has a structure of formula 1 as follows:

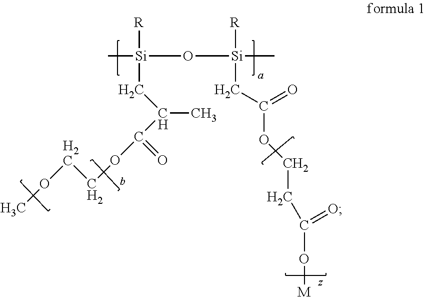

in which “R” is hydrogen or an alkyl group including 1 to 20 carbon atoms (for example, 1, 5, 10, 15, 20 carbons, or the number of carbons between the aforementioned intervals);
“M” is a metal element (for example, the Group 1 elements in Periodic Table of Elements, such as, lithium, sodium, potassium, rubidium, cesium, thorium);
“a” is an integer from 5 to 50 (for example, 5, 10, 15, 20, 25, 30, 35, 40, 45, 50, or an integer between the aforementioned intervals);
“b” is an integer from 2 to 100 (for example, 2, 10, 20, 30, 40, 50, 60, 70, 80, 90, 100, or an integer between the aforementioned intervals);
“z” is an integer from 0 to 10 (for example, 1, 2, 3, 4, 5, 6, 7, 8, 9, 10 or an integer between the aforementioned intervals).

Please refer to formula 1, the hydroxyl group of the initial electrolyte is part of the carboxyl group (the carboxyl group here corresponds to the carboxyl group of the alkenoic acid compound in the previous reactant). At step 160, a metal ion replaces hydrogen in the hydroxyl group of the initial electrolyte and creates an ionic bond with oxygen in the carboxyl group. Furthermore, the lithium-containing electrolyte also has a carbonyl group (C═O), so in addition to ionic bonds, the lithium-containing electrolyte can also carry the metal ion in a non-bonded manner. Therefore, the metal-containing electrolyte can carry multiple metal ions on its own, and when under certain appropriate conditions, it dissociates for conductive purposes (at this time, an anion segment (such as COO⁻) can provide a base of the metal ion for conduction and jumping), thereby improving conductivity. Therefore, the larger z in formula 1, the more carbonyl groups there are and the greater the number of the metal ions that can be carried.

Therefore, since the lithium-containing electrolyte itself carries conductive metal ions, it is not necessary to add additional metal salts (but additional metal salts can still be added selectively), which can avoid of changes in mechanical properties (such as too hard or too soft) of the conventional solid electrolyte caused by adding excessive metal salts.

In some embodiments, by selecting different alkenoic acid compounds, the metal-containing electrolyte with the following formula 2 (the reactant contains AA) or formula 3 (the reactant contains CEA) can be obtained:

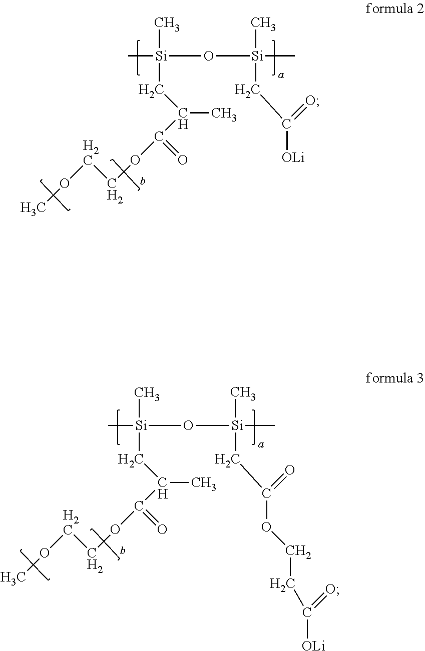

in which “a” is an integer from 5 to 50;
“b” is an integer from 2 to 100.

In some embodiments, after step S160, the method 100 includes mixing the metal-containing electrolyte and the alkali metal salt. By adding the alkali metal salt, the electrical conductivity is further improved.

In some embodiments, a weight ratio of the metal-containing electrolyte and the alkali metal salt is from 5:95 to 95:5, such as 5:95, 1:9, 1:3, 1:1, 3:1, 9:1, 95:5 or a value between the aforementioned intervals. If the weight ratio is too high, improvement of conductivity is limited. If the weight ratio is too low, the mechanical properties of the metal-containing electrolyte may be changed.

In some embodiments, the alkali metal salt includes lithium bis(fluorosulfonyl)imide (LiFSI), potassium bis(fluorosulfonyl)imide (KFSI), sodium bis(fluorosulfonyl)imide (NaFSI), lithium bis(trifluoromethanesulfonyl)imide (LiTFSI), potassium bis(trifluoromethanesulfonyl)imide (KTFSI), sodium bis(trifluoromethanesulfonyl)imide (NaTFSI), or a combination thereof. By releasing lithium ions, electrical conductivity can be improved.

The following provides a series of examples of the metal-containing electrolyte, the manufacture method and condition tests for the metal-containing electrolyte to specifically illustrate some embodiments of the present disclosure.

### EXAMPLE 1

### Manufacture Method of Metal-Containing Electrolyte

### 1. Synthesis of AAM950 (Addition of AA)

The reaction formula of AAM950 was represented as the following reaction formula 1:

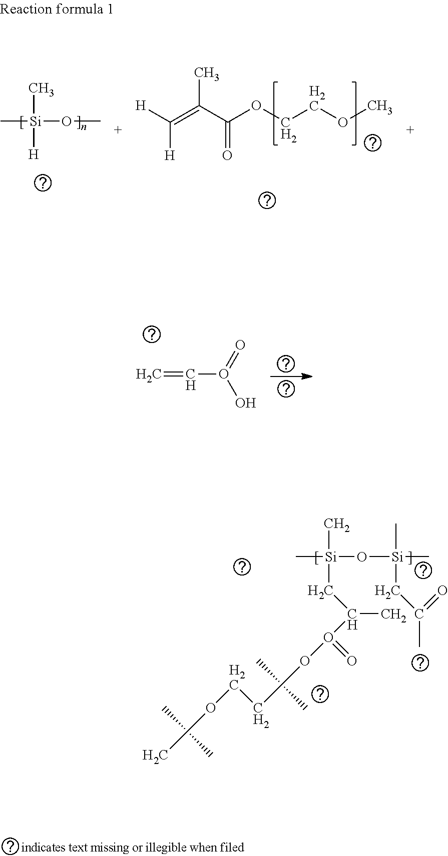

The detail procedure was as follows:

First, 0.99 g of polymethylhydrosiloxane (PMHS) [0.0165 mole, in which n in reaction formula 1 is 25-50], 12.825 g of poly(ethylene glycol) methyl ether methacrylate (PEGMEMA, in which m in reaction formula 1 is 19-20) [0.0135 mole] and 0.108 g of acrylic acid (AA) [0.0015 mole] were added to the flask, in which PMHS:PEGMEMA:AA=1.1:0.9:0.1.

Next, the flask was placed in a silicone oil bath, and the aforementioned materials were stirred at a temperature of 60±2° C. and a stirring speed of 100±5 rpm (revolutions per minute) until they were evenly dispersed. Furthermore, about 150 mL of tetrahydrofuran (THF) as the solvent and a drop of platinum as the catalyst were added to form a first mixture solution.

The first mixture solution was moved into the condensation system, and an appropriate amount of nitrogen gas was passed into the reaction bottle containing the first mixture solution to isolate the air. Then, the reaction condition that the heating temperature was 80±2° C., the stirring speed was 110±5 rpm and the stirring reaction was 78 hours were carried out to allow the alkenyl group of PEGMEMA and the alkenyl group of AA to perform a hydrosilylation reaction with the silicon-hydrogen bonds of PMHS, respectively, to form an initial electrolyte and obtain a first reaction solution having an initial electrolyte.

Next, 0.005 mole of lithium hydroxide hydrate (LiOH·nH₂O) was added to the first reaction solution to obtain a second mixture solution. An appropriate amount of nitrogen gas was introduced into the reaction bottle having the second mixture solution to isolate the air, and then the second mixture solution was stirred at a heating temperature of 80±2° C. and a stirring speed of 110±5 rpm for 24 hours to allow Li⁺ in LiOH to react with oxygen of hydroxyl group in the initial electrolyte and produce an ionic bond (replacement with hydrogen of hydroxyl group, the prelithiation reaction), thereby obtaining a lithium-containing electrolyte with a structure of formula 2 (hereinafter referred to as AAM950) in the second mixture solution after heating;

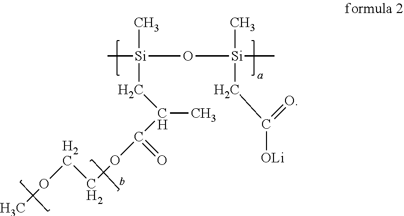

In addition, although not shown in the figure, it could be understood that since the carbonyl group (C═O) was highly dipolar, it was also highly attractive to Li ions. Therefore, each carbonyl group (C═O) of the lithium-containing electrolyte obtained by the prelithiation reaction had Li⁺ attracted by non-ionic bonding, which gave the lithium-containing electrolyte better conductivity.

Next, the condensation system was removed, and residual salts were removed through suction filtration. Then, THF through a low temperature vacuum rotary evaporator was removed to obtain a viscous slurry (containing the lithium-containing electrolyte of formula 2). Furthermore, after purifying the slurry three times with n-hexane, the slurry was placed in a vacuum oven at 70° C. for 24 hours to remove the residual solvent and obtain AAM950.

### 2. CEAM950

The reaction formula of CEAM950 was represented as the following reaction formula 2.

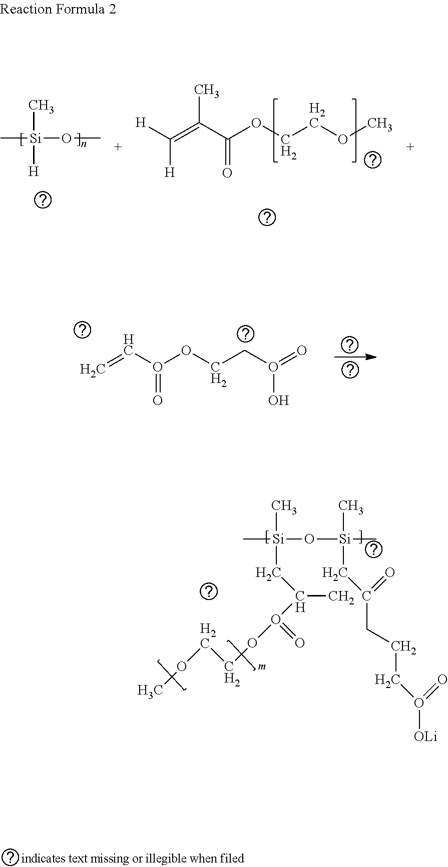

The manufacture process of CEAM950 was basically similar to that of AAM950. The difference between AAM950 and CEAM950 was that 0.108 g of AA [0.0015 mole] added in reaction formula 1 of AAM950 was replaced by 0.216 g of carboxyethyl acrylate [0.0015 mole] in the reaction formula 2 of CEAM950. Through reaction formula 2, a lithium-containing electrolyte having formula 3 structure was obtained (subsequently referred to as CEAM950);

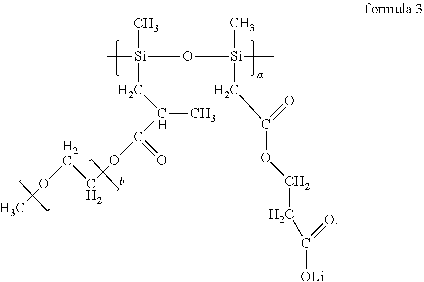

Following the description of formula 2, although not shown in the figure, it could be understood that each carbonyl group (C═O) in formula 3 had Li⁺ attracted by non-ionic bonding, which gave the lithium-containing electrolyte better conductivity.

### EXAMPLE 2

### Performance Comparison of Prelithiation and Additionally Provided Lithium Salts

In order to compare the impact of prelithiation or the addition of lithium salts on the conductivity and activation energy of the solid electrolyte, first, solid electrolyte 1 that was not prelithiated and without addition of lithium salts, solid electrolyte 2 that was not prelithiated but had addition of lithium salts and solid electrolyte 3 that was prelithiated and has addition of lithium salts were manufactured.

The manufacture method of solid electrolyte 1: similar to the raw materials and content of Example 1, however, the first reaction solution included PMHS, PEGMEMA, CEA and LiOH without the subsequent prelithiation step of heating at 80° C. Therefore, there was no ionic bonding between Li⁺ and PMHS, PEGMEMA and CEA in solid electrolyte 1.

That is, solid electrolyte 1 included the initial electrolyte+LiOH.

In other words, solid electrolyte 1 was CEAM950 (not lithiated)+0M LiFSI.

The manufacture method of solid electrolyte 2: The same method as solid electrolyte 1, but additional LiFSI was added to allow the concentration of LiFSI to be 1M and help conduct electricity.

In other words, solid electrolyte 2 contained the initial electrolyte+LiOH+1M LiFSI. That is, solid electrolyte 2 was CEAM950 (not lithiated)+1M LiFSI.

The manufacture method of solid electrolyte 3: After the same method as Example 1 (prelithiated) to obtain CEAM950, LiFSI was additionally added to allow the concentration of LiFSI to be 1M and help conduct electricity.

That is, solid electrolyte 3 contained CEAM950 (the initial electrolyte obtained by performing the lithiation reaction with LiOH)+1M LiFSI. That is, solid electrolyte 3 was CEAM950 (lithiated)+1M LiFSI.

Furthermore, each group of solid electrolytes (solid electrolyte 1, solid electrolyte 2 and solid electrolyte 3) was loaded in a Teflon container containing two stainless steel 304 electrodes, and the solid electrolyte covered the stainless steel electrodes. Teflon was then placed in the oven, and the ionic conductivity and activation energy of each group of solid electrolytes in the temperature range of 303K to 363K were calculated using Arrhenius equation, and the results were summarized in Table 1.

TABLE 1

| | | Solid Electrolyte 1 | | Solid Electrolyte 2 | | Solid Electrolyte 3 | |
|---|---|---|---|---|---|---|---|
| | | [CEAM950 (not | | [CEAM950 (not | | [CEAM950 | |
| | | lithiated) + 0M LiFSI] | | lithiated) + 1M LiFSI] | | (lithiated) + 1M LiFSI] | |
| Temperature | Temperature | Conductivity | Activation | Conductivity | Activation | Conductivity | Activation |
| (° C.) | (K) | σ (S/cm) | Energy (J) | σ (S/cm) | Energy (J) | σ (S/cm) | Energy (J) |
| 30 | 303 | 5.46E−06 | 8.30 | 1.19E−04 | 19.15 | 1.34E−04 | 19.09 |
| 40 | 313 | 6.94E−06 | | 1.90E−04 | | 2.55E−04 | |
| 60 | 333 | 1.14E−05 | | 6.12E−04 | | 6.90E−04 | |
| 80 | 353 | 1.64E−05 | | 1.72E−03 | | 1.73E−03 | |
| 90 | 363 | 1.87E−05 | | 1.76E−03 | | 2.38E−03 | |

Table 1 represented that the addition of lithium salts (LiFSI) improved conductivity and activation energy (please refer to the comparison of solid electrolyte 1 and solid electrolyte 2). Conductivity of the solid electrolyte was improved after the prelithiation treatment (please refer to the comparison of solid electrolyte 2 and solid electrolyte 3).

### EXAMPLE 3

### Performance of AAM950 and CEAM950

### 1. Conductivity and Activation Energy of AAM950 and CEAM950

In order to compare the conductivity and the activation energy of AAM950 and CEAM950, the conductivity and the activation energy of Group AAM950 and Group CEAM950 were compared using the method of first heating up and then cooling down similar to Example 2. The results were summarized in Table 2.

Furthermore, in addition to AAM950 or CEAM950, the same concentration of LiFSI (1.2M LiFSI in AAM950 or CEAM950) was also added to each group to improve conductivity to facilitate observation.

TABLE 2

| | | Group AAM950 | | Group CEAM950 | |
|---|---|---|---|---|---|
| | | (AAM950 + 1.2M LiFSI) | | (CEAM950 + 1.2M LiFSI) | |
| Temperature | Temperature | Conductivity | Activation | Conductivity | Activation |
| (° C.) | (K) | σ (S/cm) | Energy (J) | σ (S/cm) | Energy (J) |
| 30 | 303 | 1.44E−04 | 2.19 | 3.49E−04 | 4.78 |
| 40 | 313 | 2.31E−04 | 3.44 | 3.90E−04 | 5.43 |
| 60 | 333 | 3.87E−04 | 5.74 | 5.99E−04 | 8.39 |
| 80 | 353 | 8.99E−04 | 12.62 | 1.03E−03 | 14.23 |
| 90 | 363 | 1.53E−03 | 20.44 | 1.59E−03 | 21.07 |
| 80 | 353 | 1.39E−03 | 18.35 | 1.33E−03 | 17.60 |
| 60 | 333 | 8.90E−04 | 11.80 | 9.43E−04 | 12.41 |
| 40 | 313 | 3.2E−04 | 4.62 | 5.16E−04 | 6.93 |
| 30 | 303 | 2.07E−04 | 3.01 | 2.98E−04 | 4.16 |

Table 2 represented that the performances of Group AAM950 and Group CEAM950 were similar, and both had good conductivity and low activation energy.

### 2. Electrochemical Test of Group AAM950 and Group CEAM950

To further test the electrochemical performance when AAM950 and CEAM950 were manufactured as batteries, the electrochemical performances of Group AAM950 and Group CEAM950 were tested in half-cell systems, in which LiNi_{0.8}Mn_{0.1}Co_{0.1}O₂ (referred to as NCM811) was selected as the active ingredients of the working electrode, the aluminum foil was selected as the collector layer, lithium foil is selected as the auxiliary electrode, and Group AAM950 (AAM950+1.2M LiFSI) or Group CEAM950 (CEAM950+1.2M LiFSI) as mentioned in point 1 was selected as the solid electrolyte.

Detailed steps were shown as follows:

The solid electrolyte materials of AAM950+1.2M LiFSI or CEAM950+1.2M LiFSI were mixed with anhydrous oily solvent (could be N-Methyl-2-Pyrrolidone (NMP), acetone or a mixture of NMP and acetone at a ratio of 1:1) at a ratio of 1.34 g:20 mL, and then stirred at 600 rpm for 10 minutes to obtain a solid electrolyte solution.

The solid electrolyte solution and the active ingredients (NCM811) were mixed with a weight ratio of 1.34:9 to obtain an electrode mixture solution, and after stirring at 900 rpm for 10 minutes, the electrode mixture solution was then placed in a 60° C. oven to remove anhydrous oily solvent.

Furthermore, the electrode mixture solution was sieved with a 400-mesh sieve to ensure that the active ingredients were not excessively agglomerated, and then placed in a 90° C. vacuum oven for 30 minutes to ensure that the anhydrous oily solvent was completely removed, so that the active ingredients covered the materials of the solid electrolyte.

The active ingredients, the conductive carbon, the binder solution (6% polyvinylidene fluoride dissolved in N-methylpyrrolidone) were mixed at a weight ratio of 90:5:5 to obtain an electrode slurry.

After the electrode slurry was evenly coated on the aluminum foil with a thickness of 200 μm, the wet electrode was placed in a vacuum oven at 80° C. for 1 hour to be dried and form a dry electrode. Furthermore, the dry electrode was cut into a circular pole piece with a diameter of 12 mm to obtain a working electrode with impregnated solid electrolyte.

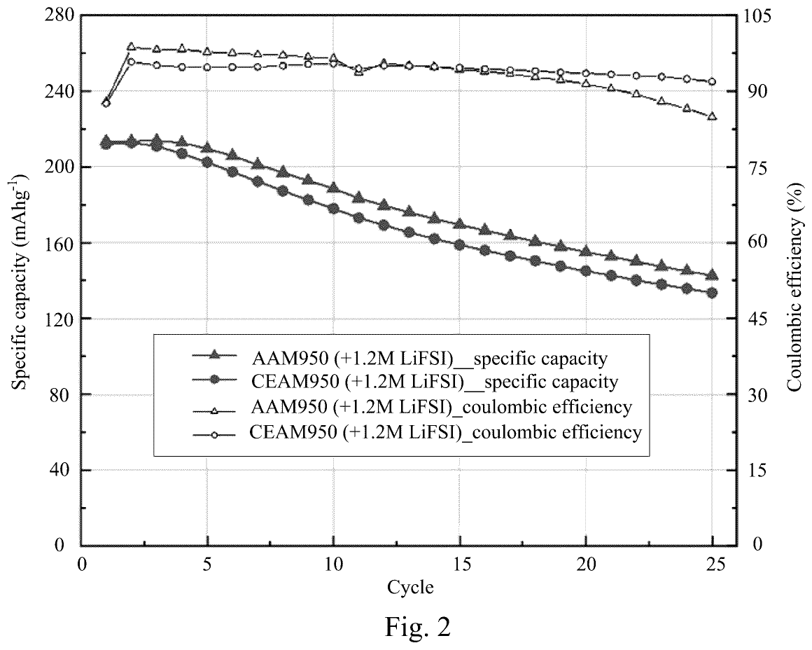

The working electrode with impregnated solid electrolyte (the solid electrolyte included Group AAM950 (AAM950+1.2M LiFSI) or Group CEAM950 (CEAM950+1.2M LiFSI) of the aforementioned point 1) and the auxiliary electrode (the lithium foil) were combined and manufactured to form a half-cell system. Then, at 60° C., a 25-cycle charge and discharge cycle test was performed at a current density of 0.1 coulomb (C) (the voltage from 2.8 volts to 4.3 volts was calculated as one cycle) to detect the relationship between specific capacity, coulombic efficiency and cycle during the charge and discharge process. Please refer to FIG. 2 for the results.

FIG. 2 represented that, the performances of the specific capacity and the coulombic efficiency between Group AAM950 and Group CEAM950 were generally similar. At the 25^{th} cycle, the specific capacity of Group AAM950 was slightly higher than that of Group CEAM950, and the coulombic efficiency of Group CEAM950 was slightly higher than that of Group AAM950.

### 3. Comparison of Electrochemical Performance Between Solid Electrolyte (Group AAM950 and Group CEAM950) and Liquid Electrolyte

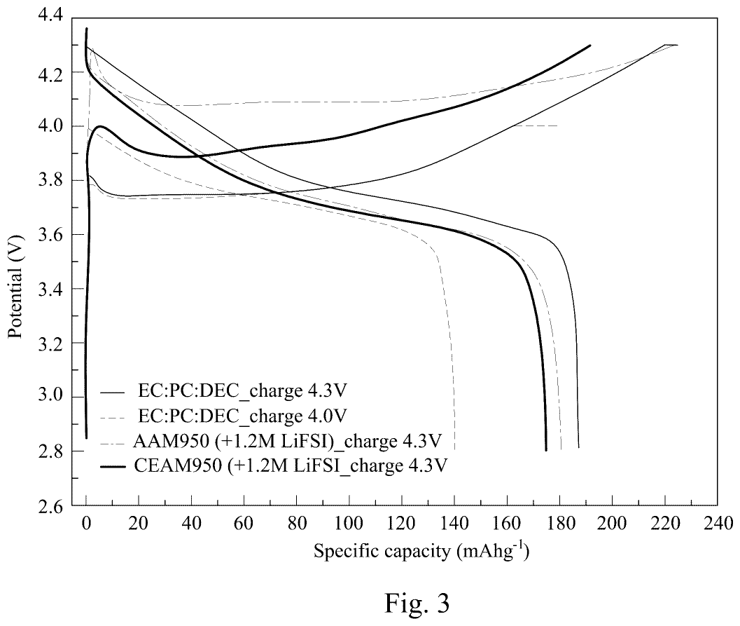

For comparing whether the electrochemical performances between the solid electrolytes of Group AAM950 (addition of lithium salts), Group CEAM950 (addition of lithium salts) as mentioned in the abovementioned point 1 and the liquid electrolyte [obtained by mixing 30 parts by volume of ethylene carbonate (EC)+20 parts by volume of propylene carbonate (PC)+50 parts by volume of diethyl carbonate (DEC), referred to as Group EC:PC:DEC] had difference, after manufacturing the half-cell systems basically similar to point 2 of Example 3 (only differing from Example 3 in that the active ingredients of the working electrode was replaced by LiNi_{0.6}Co_{0.2}Mn_{0.2}O₂ (NCM622)), a charge and discharge test was conducted at room temperature to observe the relationship between the potential and the specific capacity of each group of half-cell systems during charging. Please refer to FIG. 3 for the results.

Specifically, the step of charging included that after first discharging to 2.8 volts with a current density of 0.1 C, each group was charged with a voltage from 2.8 volts to 4.3 volts according to the operation steps of constant current-constant voltage. The discharge step included first charging to 4.3 volts with a current density of 0.1 C, and then a voltage of 4.3 volts to 2.8 volts was used for discharge. In addition, as for Group EC:PC:DEC, a group that only charged to 4.0 volts was additionally designed for comparison.

FIG. 3 represented that, compared with the liquid electrolyte (Group EC:PC:DEC), Group solid electrolyte (Group AAM950 and Group CEAM950) had the electrochemical performance similar to the liquid electrolyte.

Compared with the liquid electrolyte, the solid electrolytes had advantages such as higher safety and ease of miniaturization. Therefore, if the test examples of the solid electrolytes (Group AAM950 and Group CEAM950) of the present disclosure were applied to batteries, the batteries were more conducive to miniaturization development and had higher safety on the premise of representing the electrochemical performance similar to that of the liquid electrolyte.

At the same time, the discharge capacity and the reversibility rate (initial discharge capacity/initial charge capacity×100%, initial coulombic efficiency) were observed after the first cycle of charging and discharging, and the irreversible rate (100%−reversible rate) was calculated accordingly. The results were shown in Table 3 below.

TABLE 3

| | Upper voltage | Initial Discharge | Irreversible |
|---|---|---|---|
| Group | Limit (volts) | Capacity (mAh/g) | Rate (%) |
| Liquid Electrolyte | 4.3 | 187 | 15 |
| Liquid Electrolyte | 4.0 | 140 | 13.4 |
| Group AAM950 | 4.3 | 180 | 18.89 |
| Group CEAM950 | 4.3 | 175 | 8.53 |

Table 3 represented that, compared with the liquid electrolyte, Group CEAM950 had lower irreversible rate.

### EXAMPLE 4

### Comparison of Additionally Provided Potassium Salts or Additionally Provided Lithium Salts

Furthermore, in order to test the electrochemical performances of the batteries when the metal-containing electrolytes with different types of the alkali metal salts (the alkali metal salts were additionally added) were used as the solid electrolyte. In the half-cell systems, the electrochemical performance of the corresponding potassium ion half-cell or lithium ion half-cell was compared when the solid electrolyte contained potassium salts or lithium salts, respectively.

The active ingredients of the working electrode were a mixture of graphite, carbon black (super P) and polyvinylidene fluoride (PVDF), the copper sheet was selected as the collector layer, the lithium foil or the potassium foil was selected as the auxiliary electrode (the selection was according to the solid electrolyte. For example, when the solid electrolyte included potassium salts, the potassium foil was selected), and the solid electrolyte included Group potassium salts (CEAM950+1M KFSI) and Group lithium salts (CEAM950+1M LiFSI).

The manufacture method of the half-cell was described below:

In NMP, after the active ingredients, graphite, carbon black (super P) and polyvinylidene fluoride (PVDF), of the working electrode were mixed at a weight ratio of 90:5:5, the mixture was placed in the vacuum oven at 80° C. for drying for 12 hrs, and a coating layer of the active ingredients was obtained. Furthermore, the coating layer of the active ingredients was applied and laminated on the copper foil, and then obtaining a working electrode by cutting them to appropriate sizes.

After obtaining the working electrode, the working electrode was combined with the solid electrolyte and the auxiliary electrode and then manufactured to form a potassium ion half-cell (the auxiliary electrode: the potassium foil; the solid electrolyte: CEAM950+1M KFSI) and a lithium ion half-cell (the auxiliary electrode: the lithium foil; the solid electrolyte: CEAM950+1M LiFSI).

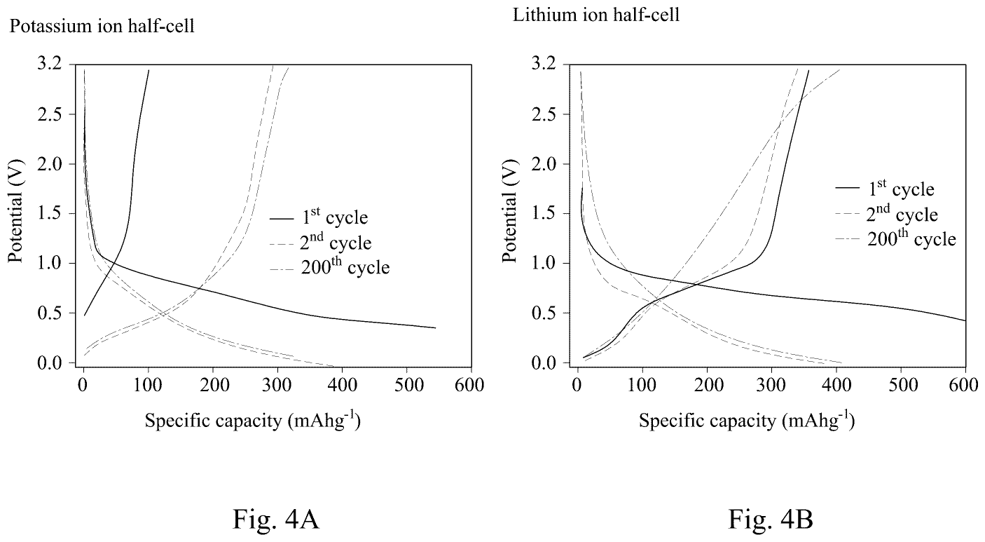

Furthermore, at 60° C., for the potassium ion half-cell and the lithium ion half-cell, 200 cycles of charge and discharge cycle tests were performed at a current density of 0.1 C (the voltage from 3.0 volts to 0.01 volts was counted as 1 circle), and the relationship between the potential and the specific capacity of the charging and discharging process was detected. Please refer to FIG. 4A (the potassium ion half-cell-Group potassium salts) and FIG. 4B (the lithium ion half-cell-Group lithium salts) for the results.

FIG. 4A and FIG. 4B represented that, regardless of whether the solid electrolyte contained the potassium salts or the lithium salts, the half-cell exhibited stable electrochemical performance.

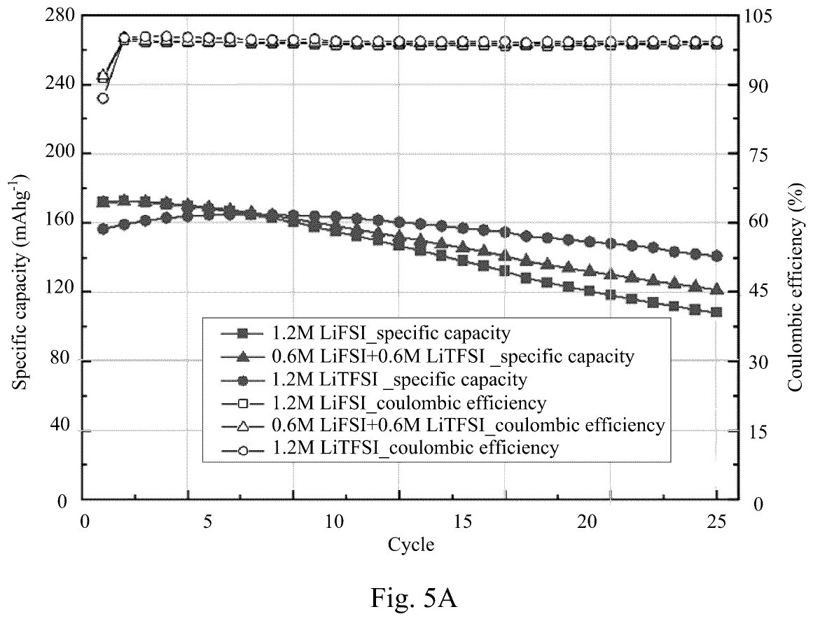

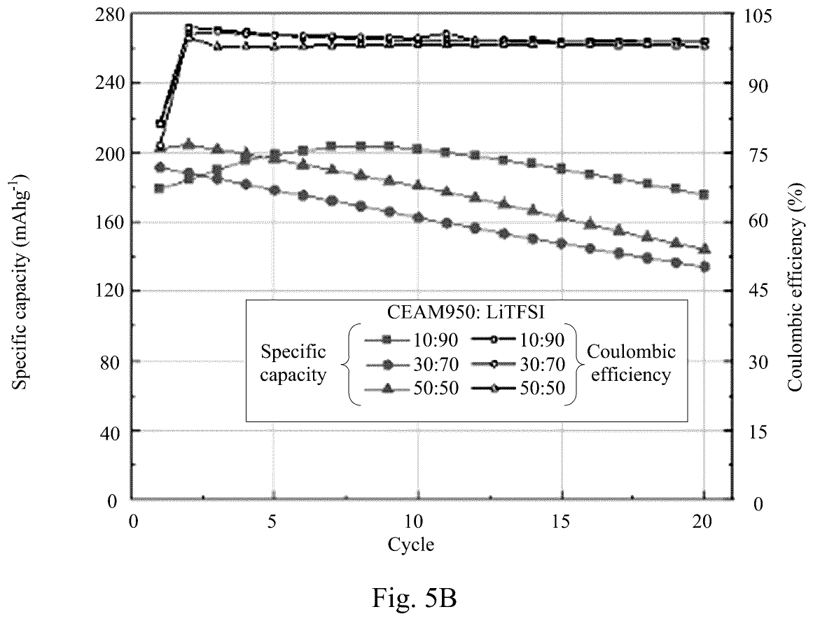

Furthermore, comparing FIG. 4A and FIG. 4B, it was observed that the potassium ion half-cell and the lithium-ion half-cell represented different feedbacks about battery performance (specific capacity) and electrochemical voltage reaction (potential). Taking the second cycle as an example, the potassium ion half-cell in FIG. 5A performed that the plateau reaction was not obvious from 0.5 volts to 1 volt, indicating that potassium ions were not contributed to the reaction during this period. Relatively speaking, in the lithium ion half-cell, the plateau reaction was obvious and continues, indicating that the lithium ions assisted the reaction at this time. Therefore, the two kinds of ions had different ionic conductivities in the solid electrolytes, giving the batteries different characteristics.

### EXAMPLE 5

### Condition Tests of Types and Ratios of Additionally Provided Lithium Salts

### 1. Different Types and Contents of Lithium Salts

In order to further test whether the solid electrolyte manufactured by the lithium-containing electrolyte including CEAM950 and the different types of the lithium salts or CEAM950 and the different ratios of the lithium salts (LiFSI, LiTFSI or mixture of both) caused difference in the electrochemical performance of the battery, the half-cell systems were manufactured basically according to the method similar to point 2 of Example 3 and then the electrochemical test was performed to detect the relationship between the specific capacity, the coulombic efficiency and the cycle during the charging and discharging process. Please refer to FIG. 5A for the results.

Specifically, the main difference between the half-cell systems here and the half-cell systems in Point 2 of Example 3 was that the solid electrolyte was replaced with Group 1.2M LiFSI (including CEAM950 and 1.2M LiFSI), Group 0.6M LiFSI+0.6M LiTFSI (including CEAM950, 0.6M LiFSI and 0.6M LiTFSI), or Group 1.2M LiTFSI (including CEAM950 and 1.2M LiTFSI).

FIG. 5A represented that compared with Group 0.6M LiFSI+0.6M LiTFSI and Group 1.2M LiTFSI, Group 1.2M LiTFSI maintained a higher specific capacity at the 30^{th} cycle. In addition, at the 30^{th} cycle, the coulombic efficiency of each group was still higher than 95%, and there was no obvious fluctuation in the coulombic efficiency between the cycles, indicating that each group of batteries had high stability.

Therefore, comparing Group 1.2M LiFSI, Group 0.6M LiFSI+0.6M LiTFSI and Group 1.2M LiTFSI, it was noticed that when the lithium salts were selected from Group LiTFSI, the battery had better electrochemical performance.

### 2. Lithium-Containing Electrolyte and Lithium Salts With Different Weight Ratios

In order to further test whether the solid electrolyte manufactured by the metal-containing electrolyte including different weight ratios of CEAM950 and the lithium salts (LiTFSI) caused difference in the electrochemical performance of the battery, the half-cell systems were manufactured basically according to the method similar to point 2 of Example 3 and then the electrochemical test was performed to detect the relationship between the specific capacity, the coulombic efficiency and the cycle during the charging and discharging process. Please refer to FIG. 5B for the results.

Specifically, the main difference between the half-cell systems here and the half-cell systems in Point 2 of Example 3 was that the electrochemical test was performed in the condition that three groups of the solid electrolytes that the weight ratios were 10:90, 30:70 or 50:50, respectively, were used. That is, in Group 10:90, the solid electrolyte contained 1.2M LiTFSI, and the weight ratio of CEAM950 and LiTFSI was 10:90.

FIG. 5B represented that that compared with Group 30:70 and Group 50:50, Group 10:90 maintained a higher specific capacity after the 5^{th} cycle (Group 50:50 took the second place, and Group 30:70 took the last place). In addition, at the 20^{th} cycle, the coulombic efficiency of each group was still higher than 95%, and there was no obvious fluctuation in the coulombic efficiency between the cycles, indicating that each group of batteries had high stability.

Therefore, comparing the performances of the solid electrolytes of the three groups of 10:90, 30:70 and 50:50, it was noticed that when the weight ratio of CEAM950 and LiTFSI was 10:90, the battery had better electrochemical performance.

### EXAMPLE 6

### Performance Comparison of Sodium-Containing Electrolyte and Liquid Electrolyte

For testing whether other metal ion similar to lithium (such as alkali metal ion) could also be used in the above-mentioned electrolyte, a sodium-containing electrolyte was manufactured by selecting sodium ion to replace lithium ion in AAM950 of Example 1. That is, the difference between the sodium-containing electrolyte and AAM950 was that the sodium-containing electrolyte contained sodium ions.

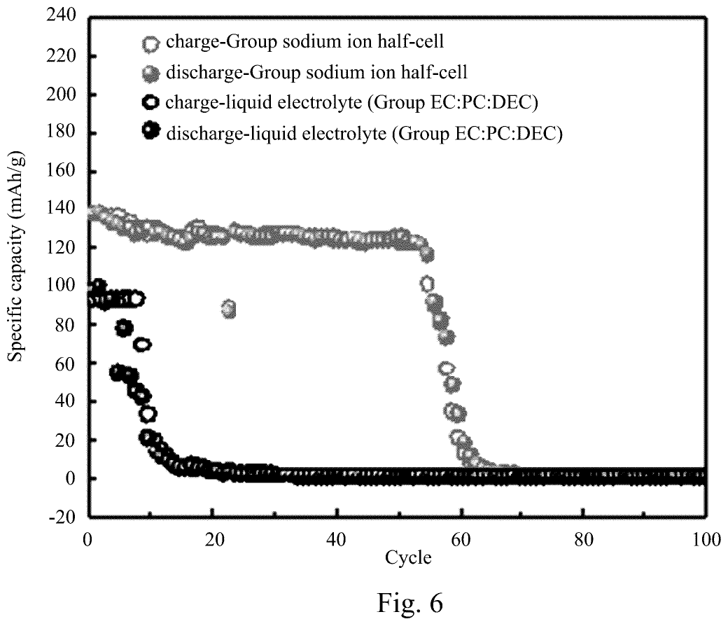

Furthermore, sodium half-cell (referred to as Group sodium half-cell) was manufactured by using the sodium-containing electrolyte basically according to point 2 of Example 3 and then a 100-cycle charge and discharge cycle test was performed at 55° C. for observing the relationship between specific capacity and cycle during the charge and discharge process, in which liquid electrolyte (Group EC:PC:DEC) mentioned in point 3 of Example 3 was served as comparative group. Please refer to FIG. 6 for the results.

FIG. 6 represented that the cycle of Group EC:PC:DEC was significantly less; therefore, battery failure was easier to occur. Relatively, electrochemical property of the sodium half-cell (including the sodium-containing electrolyte) was maintained for longer time.

Although this disclosure has been described in detail with respect to certain embodiments, other embodiments are possible. Accordingly, the spirit and scope of the appended claims should not be limited to the embodiments described herein.

What is claimed is:

1. A metal-containing electrolyte, including a structure of formula 1 as follows: 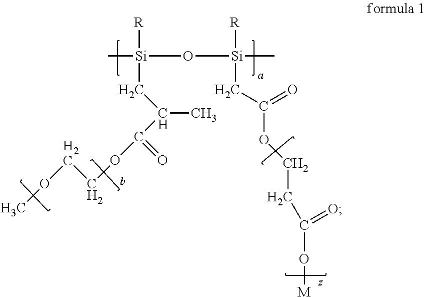
wherein “R” is hydrogen or an alkyl group including 1 to 20 carbon atoms;
“M” is a metal element;
“a” is an integer from 5 to 50;
“b” is an integer from 2 to 100;
“z” is an integer from 0 to 10.

2. The metal-containing electrolyte of claim 1, wherein M is an element of Group 1 of Periodic Table of Elements.

3. The metal-containing electrolyte of claim 1, wherein the metal-containing electrolyte has a structure of formula 2 or formula 3 as follows: 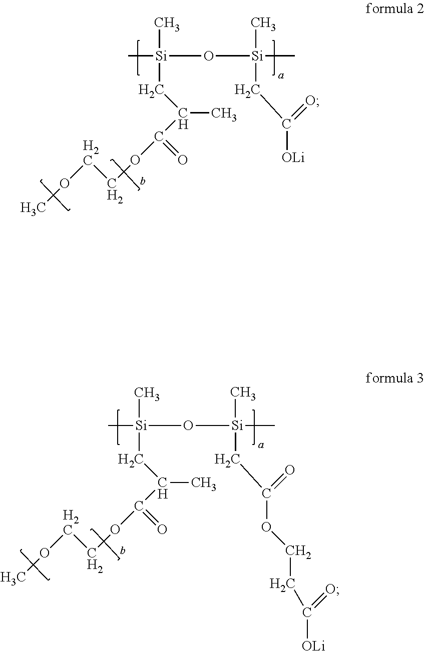
wherein “a” is an integer from 5 to 50;
“b” is an integer from 2 to 100.

4. The metal-containing electrolyte of claim 1, further including an alkali metal salt.

5. The metal-containing electrolyte of claim 4, wherein the alkali metal salt comprises lithium bis(fluorosulfonyl)imide, potassium bis(fluorosulfonyl)imide, sodium bis(fluorosulfonyl)imide, lithium bis(trifluoromethanesulfonyl)imide, potassium bis(trifluoromethanesulfonyl)imide, sodium bis(trifluoromethanesulfonyl)imide, or a combination thereof.

6. The metal-containing electrolyte of claim 4, wherein a weight ratio of the metal-containing electrolyte and the alkali metal salt is from 5:95 to 95:5.

7. A method of manufacturing a metal-containing electrolyte, including:
providing a siloxane polymer, poly(ethylene glycol) methyl ether methacrylate and an alkenoic acid compound;
mixing the siloxane polymer, the poly(ethylene glycol) methyl ether methacrylate and the alkenoic acid compound in an organic solvent, and obtaining a first mixture solution;
heating the first mixture solution to allow an alkenyl group of the poly(ethylene glycol) methyl ether methacrylate and an alkenyl group of the alkenoic acid compound to separately perform a hydrosilylation reaction with a silicon-hydrogen bond of the siloxane polymer to form an initial electrolyte, thereby obtaining a first reaction solution including the initial electrolyte;
providing a metal compound;
mixing the metal compound and the first reaction solution to obtain a second mixture solution; and
heating the second mixture solution to allow a metal ion of the metal compound to form an ionic bond with oxygen of a hydroxyl group of the initial electrolyte, and obtaining a metal-containing electrolyte.

8. The method of claim 7, wherein the siloxane polymer comprises polymethylhydrosiloxane.

9. The method of claim 7, wherein the alkenoic acid compound comprises acrylic acid, carboxyethyl acrylate, or a combination thereof.

10. The method of claim 7, wherein at the step of mixing the siloxane polymer, the poly(ethylene glycol) methyl ether methacrylate and the alkenoic acid compound in the organic solvent, a molar ratio of the siloxane polymer and the poly(ethylene glycol) methyl ether methacrylate is from 1:5 to 5:1.

11. The method of claim 7, wherein at the step of mixing the siloxane polymer, the poly(ethylene glycol) methyl ether methacrylate and the alkenoic acid compound in the organic solvent, a molar ratio of the poly(ethylene glycol) methyl ether methacrylate and the alkenoic acid compound is from 1:5 to 5:1.

12. The method of claim 7, wherein the organic solvent comprises tetrahydrofuran, n-hexane, or a combination thereof.

13. The method of claim 7, wherein the step of mixing the siloxane polymer, the poly(ethylene glycol) methyl ether methacrylate and the alkenoic acid compound in the organic solvent comprises adding platinum.

14. The method of claim 7, wherein the step of heating the first mixture solution comprises heating the first mixture solution in an inert gas atmosphere at from 70° C. to 90° C.

15. The method of claim 7, wherein the metal compound comprises a metal ion of Group 1, Group 2, or a combination thereof of Periodic Table of Elements.

16. The method of claim 7, wherein at the step of mixing the metal compound and the first reaction solution, a molar ratio of the alkenoic acid compound and the metal compound is from 1:20 to 20:1.

17. The method of claim 7, wherein the step of heating the first mixture solution comprises heating the second mixture solution in an inert gas atmosphere at from 70° C. to 90° C.

18. The method of claim 7, wherein after the step of heating the second mixture solution, the method comprises mixing the metal-containing electrolyte and an alkali metal salt.

19. The method of claim 18, wherein a weight ratio of the metal-containing electrolyte and the alkali metal salt is from 5:95 to 95:5.

20. The method of claim 18, wherein the alkali metal salt comprises lithium bis(fluorosulfonyl)imide, potassium bis(fluorosulfonyl)imide, lithium bis(trifluoromethanesulfonyl)imide, potassium bis(trifluoromethanesulfonyl)imide, or a combination thereof.
